(19) United States
(12) Patent Application Publication
(10) Pub. No.: US 2010/0042328 A1
(43) Pub. Date: Feb. 18, 2010

(54) Seismic sensor with micro machined accelerometers

(76) Inventor: William Diaz-Lopez, Kissimmee, FL (US)

Correspondence Address: JOHN RYZNIC, FLORIDA TURBINE TECHNOLOGIES, INC., 1701 MILITARY TRAIL, SUITE 110, JUPITER, FL, 33458-7887, US

(21) Appl. No.: 12/368,950

(22) Filed: Feb. 10, 2009

Related U.S. Application Data
(63) Continuation-in-part of application No. 12/098,265, filed on Apr. 4, 2008.
Application No. 12/098,265 is a continuation of application No. 11/081,977, filed on Mar. 16, 2005, now abandoned.
Application No. 11/081,977 is a continuation-in-part of application No. 11/015,134, filed on Dec. 17, 2004, now Pat. No. 7,042,365.
Application No. 11/015,134 is a continuation-in-part of application No. 10/439,160, filed on May 15, 2003, now Pat. No. 6,909,375.
(60) Provisional application No. 60/381,372, filed on May 20, 2002.

(51) Int. Cl. G01V 1/00

(52) U.S. Cl. 702/15

(57) ABSTRACT

A seismic switch is a programmable device capable of distinguishing between seismic movements due to an earthquake or an explosion, which is used to send a signal to control panels for security doors. The device uses accelerometers and a microcontroller for the detection and signal analysis of the seismic movements. In the event of an explosion or earthquake, the device produces an alarm. The accelerometers are low G micro machined accelerometers that include signal conditioning, a 2-pole low pass filter and temperature compensation with CMOS signal conditioning ASIC contained in a single integrated circuit sealed hermetically at the wafer level.

### CROSS-REFERENCE TO RELATED APPLICATIONS

This application is a Continuation In Part of U.S. patent application Ser. No. 12/098,265 filed on Apr. 4, 2008; which is a Continuation of U.S. patent application Ser. No. 11/081,977 filed on Mar. 16, 2005; which is a CIP of Ser. No. 11/015,134 filed on Dec. 17, 2004 and issued as U.S. Pat. No. 7,042,365; which is a CIP of U.S. patent application Ser. No. 10/439,160 filed on May 15, 2003 and issued as U.S. Pat. No. 6,909,375; which claims the benefit to U.S. Provisional application 60/381,372 filed May 20, 2002.

### FEDERAL RESEARCH STATEMENT

None.

### BACKGROUND OF THE INVENTION

1. Field of the Invention

The present invention relates generally to seismic detection systems and methods of operating such systems, and more specifically to a system and method which permits periodic testing of the alarm function.

2. Description of the Related Art Including Information Disclosed under 37 CFR 1.97 and 1.98

Modern security systems have become increasingly sophisticated. Today, they are able to monitor for break-ins, smoke, fire, chemical releases and a host of other conditions requiring appropriate response. Often, these security systems interface not only with alarms to alert people of the emergency condition but also with remote monitoring facilities and emergency response teams such as police or fire departments. In addition, these security systems can control the activation of sprinklers, the release of doors and other control functions.

Upon detection of smoke, fire or other emergency conditions, it is critical to release doors, especially in crowded commercial establishments. The failure to release a single door can cause crowd panic and has in some instances resulted in the loss of life. For this reason, many methods have been applied to releasing doors under emergency conditions.

Some representative examples include: (1) U.S. Pat. No. 6,265,979 issued to Chen and entitled EARTHQUAKE SENSING DEVICE; (2) U.S. Pat. No. 6,049,287 issued to Yulkowski and entitled DOOR WITH INTEGRATED SMOKE DETECTOR AND HOLD OPEN; (3) U.S. Pat. No. 5,429,399 issued to Geringer et al and entitled ELECTRONIC DELAYED EGRESS LOCKING SYSTEM; and (4) U.S. Pat. No. 4,803,482 issued to Verslycken and entitled EXIT CONTROL AND SURVEILLANCE SYSTEM. Each is incorporated herein in their entirety and each is described briefly in turn.

The Chen patent (U.S. Pat. No. 6,265,979) generally teaches a device for detecting an earthquake and for controlling emergency functions. The device measures both horizontal and vertical vibrations. Based upon those measurements, the device determines whether an earthquake has occurred and if so releases doors.

The Yulkowski patent (U.S. Pat. No. 6,049,287) generally teaches a door control device that automatically releases a door upon detection of smoke. The door control device is physically mounted on the door and releases associated electronic locks.

The Geringer patent (U.S. Pat. No. 5,429,399) generally teaches a door control device that receives various alarm signals including smoke or seismic activity. In response to these alarm signals, the door control automatically releases associated door locks.

The Verslycken patent (U.S. Pat. No. 4,803,482) generally teaches a door release and surveillance system. The door release is requested by a person by pressing a release lever at the door. This sends a signal to a central control location. The central location can monitor the door through a surveillance system. In response to the request it can elect to permit the door to release. Alternatively, it can delay or prevent the door to release should the central control location determine that there is not an emergency condition and the door should remain locked.

While each of these systems may serve their intended purpose, an important practical consideration is testing. Just like a fire alarm system, a seismic detection system should be periodically tested to ensure that it remains in proper operational condition. Accordingly, a system is desired which permits convenient, periodic testing.

### BRIEF SUMMARY OF THE INVENTION

It is an object of the present invention to provide a system capable of detecting seismic activity and it is a further object of the present invention that such system permits convenient, periodic testing.

According to one aspect of the present invention, a seismic detection system includes a housing, at least two seismic sensors, detection circuitry, an indicator and at least one external device. The seismic sensors are contained within the housing and generate electrical signals in response to seismic movement. The detection circuitry is also contained within the housing and is operably coupled with the seismic sensors to receive the signals. The detection circuitry is configured to detect the occurrence of a seismic event based on the signals. The indicator is mounted on the housing and is operably coupled with the detection circuitry. The indicator is configured to generate an alarm upon detection of the seismic event. The external device communicates with the detection circuitry and is positioned remotely from the housing. It is configured to perform additional security functions. The seismic sensors are micromachined accelerometers made by Freescale Semiconductors with model no. MMA 1260D which have very accurate and sensitive motion detection.

According the further aspects of the invention, the seismic sensors are accelerometers and are positioned perpendicular with respect to each other. The housing is provided with monitoring holes for securing the housing to a building. The detection circuitry included at least two amplifiers, a processor and at least one relay. The amplifiers each receive signals from a corresponding one of the seismic sensors to generate amplified signals. The processor, which receives the amplified signals, is configured to determine the occurrence of the seismic event based on analysis of the amplified signals. The relay, upon detection of the seismic event, activates the at least one indicator. The processor is further configured to classify the seismic event as being either of an earthquake or an explosion. The indictor is either an audible alarm or a light indicator. The external device is either a fire detection system, an intrusion detection system, a door release mechanism or a communications link. The communications link is configured to notify emergency personnel upon detection of the seismic event.

According to further aspects of the present invention, the seismic detection system includes a ready condition indicator and a manual reset switch. The ready condition indicator is connected to the detection circuitry and comprises an LED mounted on the housing. Upon activation, it indicates that the system is operational. It is de-activated upon detection of the seismic event. The manual rest switch is operably connected to the ready condition indicator and the detection circuitry. It is configured to allow resetting the seismic detection system after detection of the seismic event.

According to another aspect of the present invention, a seismic detection system comprises a housing, three seismic sensors, detection circuitry, a ready indicator light, at least one alarm indicator and at least one external device. The seismic sensors are located within the housing positioned orthogonally with respect to one another. The sensors generate electrical signals in response to seismic movement. The detection circuitry is contained within the housing and receives the electrical signals. The circuitry is configured to detect the occurrence of a seismic event based on analysis of the electrical signals and to classify the seismic event as either an earthquake or an explosion. The ready indicator light is mounted on the housing and connected with the detection circuitry to indicate that the system is operational. The alarm indicator is mounted on the housing and is connected with the detection circuitry, configured to be activated upon detection of the seismic event. The external device is positioned remotely from the housing and in communication with the detection circuitry to perform additional security functions.

According to another aspect of the present invention, the seismic sensors are accelerometers. The detection circuitry comprises three amplifiers, a processor, a first and a second relay and a communication link. The amplifiers each receive electric signals from a corresponding one of the seismic sensors and generate amplified signals. The processor receives the amplified signals and is configured to detect the occurrence of a seismic event upon analysis of the amplified signals. The processor is further configured to classify the seismic event as an earthquake or an explosion. The first relay is connected to the processor and is configured to activate the at least one alarm indicator upon detection of an earthquake. The second relay is connected to the processor and is configured to activate the at least one alarm indicator upon detection of an explosion. The second relay is further configured to activate the communications link to alert emergency personnel upon detection of an explosion.

According to further aspects of the present invention, the external device is a fire detection system, an intrusion detection system or a door release mechanism. The ready indicator light comprises an LED mounted on the housing which, upon activation, indicates that the system is operational and which is de-activated upon detection of the seismic event. A manual reset switch is operably connected to the ready indicator light and the detection circuitry. It is configured to allow resetting the seismic detection system after detection of the seismic event. The processor is further configured to periodically sample signals from the sensors during a predetermined period of time and to assess whether the ready indicator light will remain activated, thereby performing a periodic self-test of the system.

According to another aspect of the present invention, the seismic detection system comprises: (1) a means for resetting seismic movement and generating electrical signals in response thereto; (2) a means for processing the electrical signals and determining, based upon analysis of the signals, the occurrence of a seismic event and for classifying the seismic event as being either an earthquake or an explosion, wherein the means for processing performs periodic self-test of the system by periodic sampling of the signals during a predetermined period of time; (3) a means for indicating operating conditions of the system, connected to the processing means to indicate that the device is operational as a result of the self-test; (4) at least one alarm indicating alarm indicating means for warning detection of the seismic event by the processing means; and (5) at least one external device communicating with the processing means, configured to perform additional security functions.

### BRIEF DESCRIPTION OF THE SEVERAL VIEWS OF THE DRAWINGS

FIG. 1 is an exploded view of one preferred embodiment of a seismic switch.

FIG. 2 is a functional block diagram of the seismic switch.

FIG. 3 is a flowchart of the control algorithm for the seismic switch.

FIG. 4 is a perspective view of the seismic switch depicting the angle made from the signal to the seismic switch X-axis.

FIG. 5 is a graph showing the values required for earthquake-actuated automatic gas shutoff devices (ASCE 25-97) and the seismic switch.

FIG. 6 is a functional block diagram of the seismic switch as it interacts with a typical security access control circuit.

FIG. 7A is a perspective view of a control panel (either fire or door), including a seismic detection system.

FIG. 7B is a perspective view of a control panel of FIG. 7A, where the seismic detection system has been removed and placed upon a vibration table for testing.

FIG. 7C is an exploded view of the mounting system for the seismic detection system of FIG. 7A from a front perspective.

FIG. 7D is an exploded view of the mounting system for the seismic detection system of FIG. 7A from a back perspective.

FIG. 8 is the seismic detection system similar to that of FIG. 7A, but in a floor-mount configuration.

### DETAILED DESCRIPTION OF THE INVENTION

In one preferred embodiment, a seismic detection and control circuit is connected with an external security or fire system capable of activating alarms, releasing doors, initiating emergency calls and other control functions. In the event of seismic activity, the detection circuit determines whether an explosion or an earthquake has occurred. If so, the control circuit activates the external security systems. In the event of an explosion, the alarm condition is forwarded to emergency responders such as the fire department. In the event of an earthquake, the alarm condition is not forwarded to emergency responders to avoid over-loading their communication systems (and the emergency responders in the area would not need notice because they would also be experiencing the earthquake conditions). Preferably, the seismic detection and control circuit is enclosed within an explosion proof box. On the front face, status lights indicate whether the device is active and whether an alarm condition has been detected, and control switches for testing and resetting the detection and control circuit are accessible to a user. Preferred embodiments and methods of operation are described further below with reference to the figures.

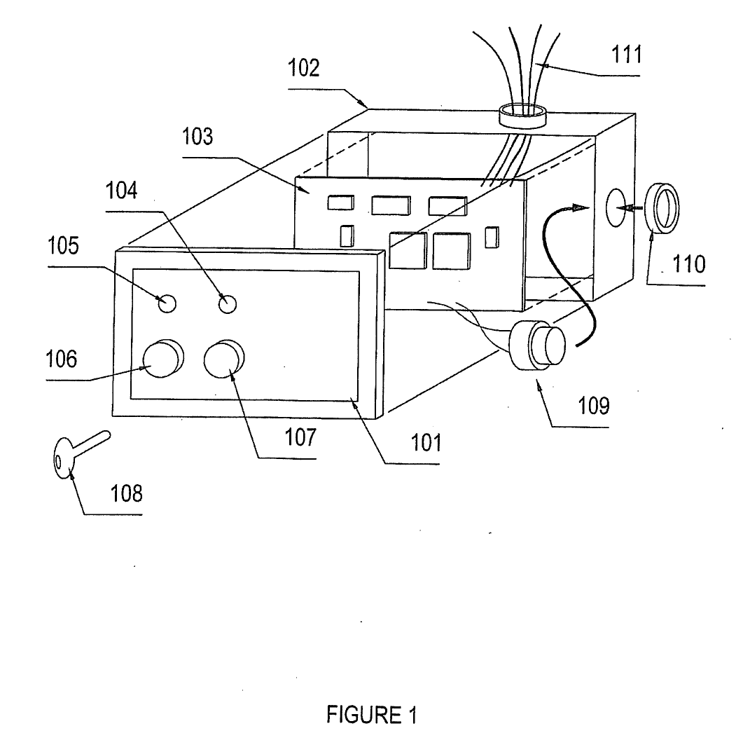

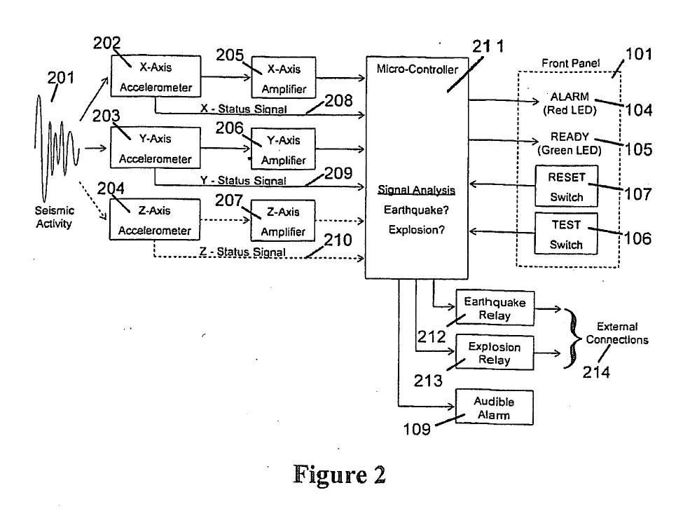

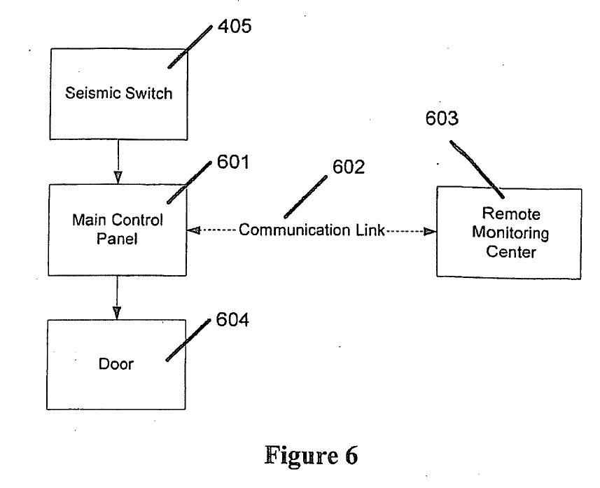

Turning to FIG. 1, one preferred embodiment of a seismic control switch is described. Specifically, a seismic switch control circuit 103 is enclosed in a metal case 102 and has on the front panel 101 two push-button or keyed switches 106 and 107 and two indicator lights in the form of light emitting diodes or LEDs 104 and 105. The front panel 101 and the metal case 102 have mounting holes proximate their corners to permit mounting bolts to pass through for securing the seismic control switch in place. A red LED 104 is labeled “Alarm”. This light's turning on means that the microcontroller analyzed the detected vibrations and concluded that the vibrations were due to either an earthquake or an explosion and that an ALARM condition exists. A green LED 105 is labeled “Ready”. This LED indicates that the system has performed a self test and that all tested parts are working correctly. The switch labeled “Test” 106 is used to instruct the microcontroller to test the ALARM condition, the relays 212 and 213, which are shown in FIG. 2, the audible alarm buzzer 109, and the external circuit to which the seismic switch is connected (601, 602, 603 and 604 which are shown in FIG. 6). The audible alarm 109 is mounted on a side wall of the metal case 102 and is held in place by an external nut 110. The “Reset” switch 107 forces the microcontroller to clear the ALARM condition and to return to the initial state, including performing the “Test” function described above. Wires 111 for power and other connections to the external security system pass through a hole in the top face of the metal case 102.

Turning to FIG. 2, one preferred embodiment of the detection and control circuit is further described. During normal operation, the “Ready” LED 105 remains on. If a seismic signal 201 is detected by the accelerometers (202, 203, 204), it is decomposed into X, Y and Z components and converted to electronic signals. These are passed through amplifiers (205, 206, and 207) and are input into the microcontroller 211 for signal analysis. The analysis determines whether the incoming signals correspond to an earthquake, an explosion, or neither. If the signals are interpreted as being those resulting from an earthquake, the ALARM LED 104 is turned on, the “Ready” LED 105 is turned off, the earthquake relay 212 is activated, and the audible alarm 109 is turned on. If the signals correspond to an explosion, a similar sequence of events is triggered; the ALARM LED 104 is turned on, the Ready LED 105 is turned off, the explosion relay 213 is activated, the audible alarm 109 is turned on, and, in addition, an emergency communication system 603 is activated by the explosion relay 213 to inform emergency responders such as the fire department. The circuit can only be reset back to normal operation through the manual activation of the RESET switch 107 by authorized personnel. In one preferred embodiment, a keyed switch is used, sop that resetting the device requires the right key 108. In another preferred embodiment, the reset is a pushbutton switch. So that only authorized persons can reset the device, the seismic switch is mounted within keyed box or otherwise restricted area.

The circuit for the two-dimensional seismic switch is composed of eight main components as shown in FIG. 2, namely two accelerometers 202 and 203, two amplifiers 205 and 206, a microcontroller 211, two relays 212 and 213, and a buzzer 109. Each accelerometer-amplifier pair corresponds to one of the Cartesian X and Y directions making up the horizontal plane, with a 90 degree angle between their axes, The extra components needed for the three-dimensional version of the seismic switch are also shown in FIG. 2 using dashed lines: an accelerometer 204 and an amplifier 207. These would be used to detect vibrations in the Z (or vertical) direction. The accelerometers convert changes in velocity (acceleration) into electronic voltage signals. These signals are then amplified to increase the instrument's sensitivity to seismic movements 201. The amplified signals are then fed into the microcontroller's analog-to-digital converters (ADCs), which automatically convert the signals to digitally encoded representations of the signals. The microcontroller 211 has subroutines to continuously monitor incoming signals and, in the event that it recognizes a signal's characteristics as those pertaining to an earthquake or an explosion, it activates the earthquake relay 212 or the explosion relay 213, respectively. At the same time, an audible signal is produced by the buzzer 109. The signal patterns of interest have been pre-programmed into the microcontroller 211 using tables that correlate each accelerometer's digitally encoded signal amplitudes, plus the signal's period, and thus its frequency. These tables are explained below, as part of the microcontroller's programming.

The microcontroller unit 211, or MCU, chosen to implement the seismic switch is a Motorola MC68HC908GP32 8-bit microcontroller. This microcontroller has 32 kB of FLASH memory, so that it can be programmed using C code to suit the application's needs. In addition, the MCU has two timers, eight channels of analog-to-digital converters, and a serial port, which allows for programming the unit after installation.

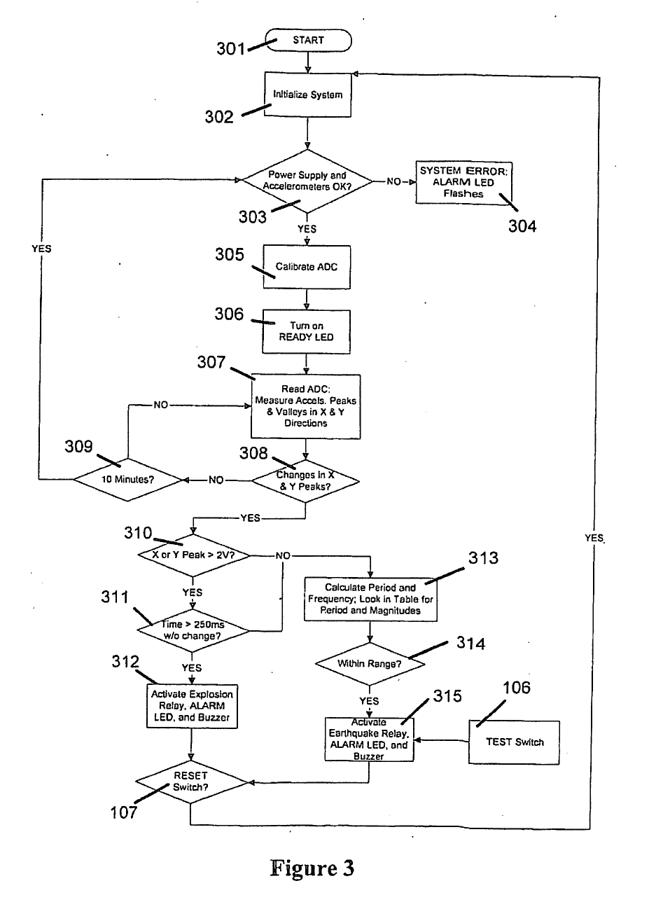

Turning to FIG. 3, one preferred method of operating the seismic switch is described. When the unit is initially turned on 301 or RESET 107 switch is activated, the MCU initializes 302 the complete system, checks the power supplies and accelerometers 303, and then proceeds to take samples at the ADC inputs being used in order to calibrate the system 305. The accelerometers-have status signals (208, 209, and 210) that are monitored by the MCU. If an error is detected during the initialization or testing stages 303, the MCU will make the red ALARM LED 104 continuously flash to indicate that a system error has occurred 304. Once the MCU has initialized, tested and calibrated the unit, it turns on the green Ready LED 105 to indicate that the system is working properly 306.

The MCU then goes into its regular mode of operation. It will read data 307 from the accelerometer-amplifier pairs to monitor changes in either the X or Y signals amplitudes. While sampling is performed, the peaks and valleys pertaining to each signal are averaged to reduce possible noise and false alarms. If ten minutes pass 309 and there are no significant and sustained changes in any of the peaks or valleys 308, the MCU will cycle through the testing and calibration sections and repeat the monitoring stage for another ten minutes. This pattern of sampling for ten minutes and testing will go on until changes occur in the peaks and valleys 308 or until the unit is set to the TEST mode via the TEST switch 106, to REST mode with the RESET switch 107, or if the unit is turned off by disconnection.

In order to detect the occurrence of an explosion, the occurrence of amplifier output saturation is monitored. If either X or Y amplifier 205 and 206 voltages exceed two volts 310 (corresponding to 0.33 g) for 250 milliseconds 311, the signal is interpreted as being due to an explosion and the action pertaining to an explosion 312 are taken: namely, the ALARM LED 212 is turned on, the audible alarm is activated 109, and emergency call is placed to a central monitoring center 603 and the local authorities through a communication link 602. Since averaging of the input signals is being performed, noise effects and transients are filtered, thus minimizing the possibility of false triggering.

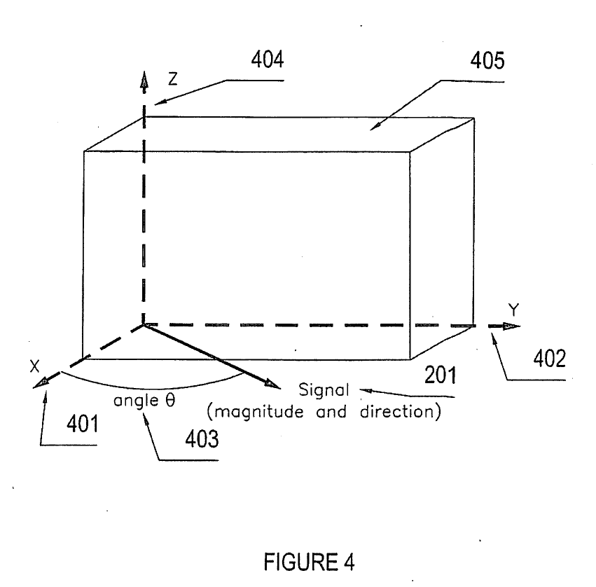

With reference to FIG. 4, the principle operation behind one preferred earthquake signal analysis algorithm is now described. When a traveling signal 201 approaches a point in space, it possesses two important components, namely magnitude and direction, which together define the signal as a vector. If the magnitude and direction are known, the signal vector can be decomposed into X and Y components in the X 401 and Y 402 axis, respectively. By defining the angle (direction) between the X-axis 401 and the signal vector 201 as theta (θ) 403, simple trigonometry allows for vector decomposition into X and Y components: the X component being the signal's amplitude times the cosine of θ, and the Y component being the signal's amplitude times sine of θ. At the same time, the acceleration forces (relative to Earth's gravitational acceleration, g) in an earthquake's signal represent the magnitude of the vector. Thus, the key element for the seismic switch 405 is to determine if the signal's amplitude, frequency and duration is that from an earthquake. The amplitude requirement to be analyzed by setting an acceleration threshold value, so that if the signals' magnitude (acceleration) is greater than this threshold, it establishes the possibility that the signal might be that from an earthquake. To accomplish this, the threshold is decomposed into its X and Y components, converted to their respective digital equivalent representations and included in the code as a table. This allows for the MCU to compare these values to the digitalized signals from the X and Y accelerometers. Of both the X and Y components of the detected signal are larger than the corresponding threshold values 308, the signal could be that from an earthquake.

The signal's period and/or frequency are then needed to complete this two-part test. The program uses one of the MCU's internal timers to keep track of when peaks or valleys occur for each of the accelerometer-amplifier pairs (X and Y). The time difference between occurrence of a leak and a valley corresponds to half a cycle, so by multiplying this time difference by two, the instantaneous signal period is obtained. A second table is used to correlate the period to the signal's intensity 313 (which step is shown in FIG. 3). If the overall signal magnitude (combination of X and Y) is larger than the threshold for a particular time period, the signal is interpreted as being that from an earthquake 314. The microcontroller then proceeds to the earthquake ALARM condition 315. Here, the ALARM LED 104 and buzzer 109 are activated, along with earthquake relay 212. These remain activated until reset 107.

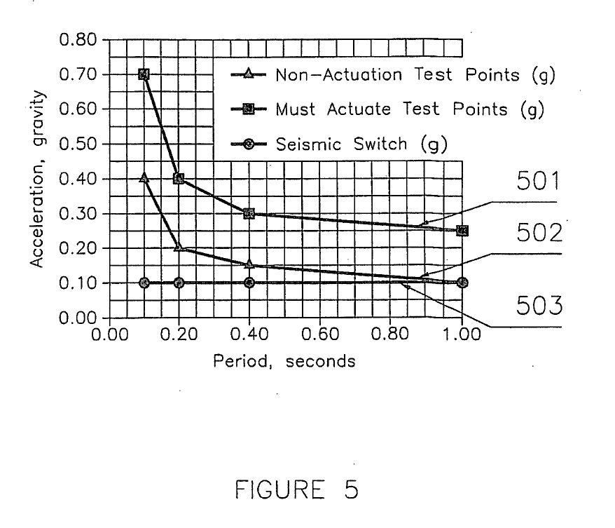

Turning to FIG. 5, the operating parameters for automatic gas-valve shut-off devices as promulgated by ASCE standard 25-97 are shown along with the one preferred set of operating parameters for the seismic switch. Acceleration is plotted along the vertical axis and period is plotted along the horizontal axis. The must-actuate test points are shown along line 501. If a signal exceeds this line, under the ASCE standard 25-97, the gas-valve shut-off device must turn off. The non-actuation test points are shown along line 502. If a signal falls below this line, under the same standard, the gas-valve shut-off device may not turn off. The preferred threshold for the seismic switch is shown along line 503. Notably, it falls entirely below line 501, and only meets line 502 at the right-most data point.

This lower threshold is chosen to release doors even though only minor seismic activity has been detected. In applications such as a crowded commercial establishment, the seismic switch may be used to control the release of doors either directly or through a security system. When a minor earthquake occurs, it may not require that gas vales or similar such devices be turned off, but may still frighten people. In the event, if emergency doors were to remain locked and closed, people in a crowded commercial establishment may panic and rush for other exits. Such crowd panic can have seriously devastating results. To avoid this, emergency doors should be released even upon detection of minor seismic activity.

Accordingly, if a signal being measured has a magnitude larger than that specified for the actuation threshold for the signal's period, the valve must be shut off. In order to make the seismic switch more sensitive to earthquakes, a threshold value of approximately 0.1 g, or more precisely and preferably 0.07 g, is used for all signal periods between 0 and 1 second as illustrated in FIG. 5. (This is equivalent to a VI on the Mercalli Scale) in this manner, if a signal is being interpreted as that from an earthquake, the seismic switch activates 315 the corresponding relay 212 and the audible alarm 109.

Turning to FIG. 6, one preferred interaction between a seismic switch 405, a main control panel 601 to which the switch 405 is connected, a door 605 being controlled by the control panel 601, and a communication link 602 connecting to a remote monitoring center 603 is shown. In operation, the seismic switch 405 monitors for seismic signals. If any are detected, it determines whether it is an earthquake or an explosion. In the event of an earthquake, an earthquake signal (indicated by a closing relay) is sent to the main control panel 601; in the event of an explosion, an explosion signal (also indicated by a closing relay) is sent to the main control panel 601. The main control panel 601 includes other security functions. For example, it receives fire detection, intrusion and any other security related signals. In response to an earthquake signal, the main control panel 601 releases doors 604. In a preferred embodiment, the main control panel 601 does not call the remote monitoring center 603 because if all security systems were to place such a call during an earthquake all circuits would become busy. In alternative embodiments, it could, nonetheless, place such a call. In response to an explosion signal, the main control panel 601 releases doors 604 and calls the remote monitoring center 603, which notifies the emergency responders (e.g., fire department). The doors 604 can be standard doors such as those used in the patents described above along with the background of the invention. Alternatively, the doors 604 may be part of a security door system used in banks and other commercial establishments (also known as man-trap doors) and as described in U.S. Pat. No. 6,308,644 entitled FAIL SAFE ACCESS CONTROL CHAMBER SECURITY SYSTEM, and U.S. Pat. No. 6,298,603 entitled ACCESS CONTROL VESTIBULE, both by the instant inventor and both of which are expressly incorporated herein by reference in their entirety.

Alternatively, the seismic switch can be used to control the release of one or more doors directly without a main control panel.

When the seismic switch is used along with delayed-egress fire doors, detection of a seismic event over-rides the delay so that the doors release immediately.

Physically, the main control panel typically is constructed of a metal box having a keyed access door. The seismic switch as shown and described is approximately the size of a standard 12 volt, 4 amp, d.c. current battery so that it can fit inside the box containing the main control panel. More particularly, the dimensions of the seismic switch do not exceed five inches in height, width or depth. More preferably, the seismic switch is approximately three and one half inches high, four and one half inches wide, and two and one half inches deep. Although the seismic switch can be smaller or larger, this approximate size is preferred because a smaller size can be difficult to firmly mount on a vibration table used for testing.

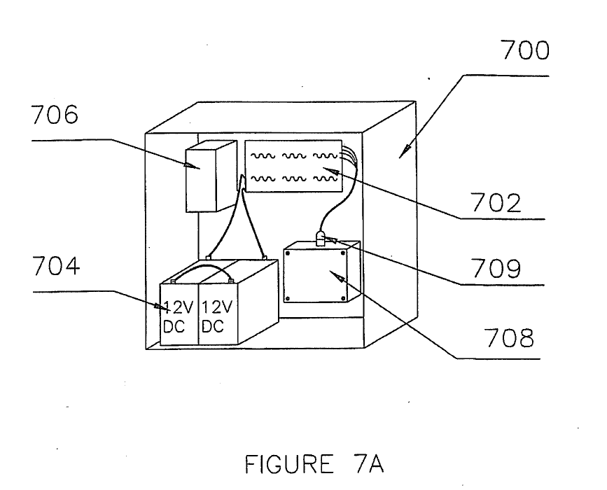

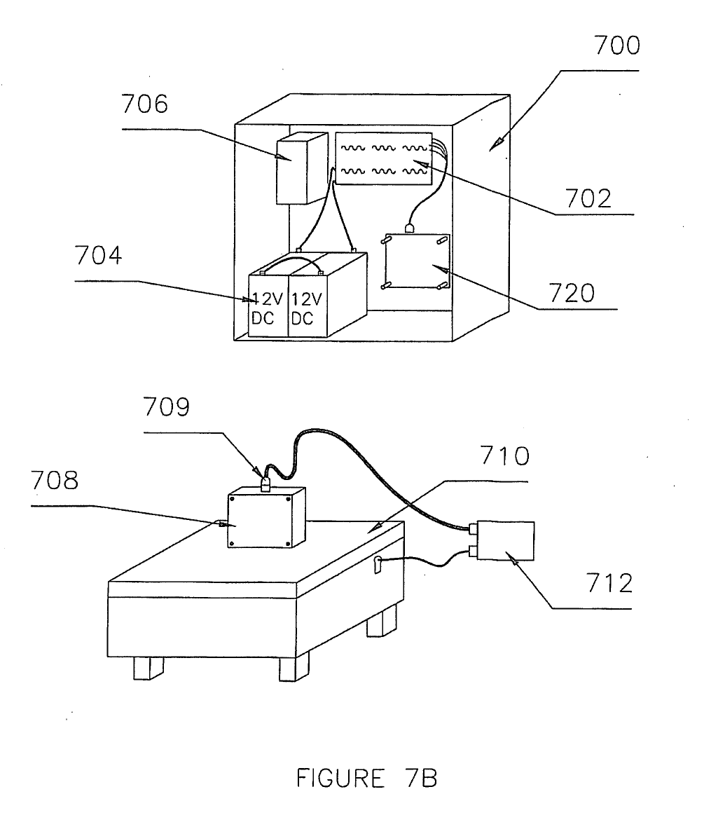

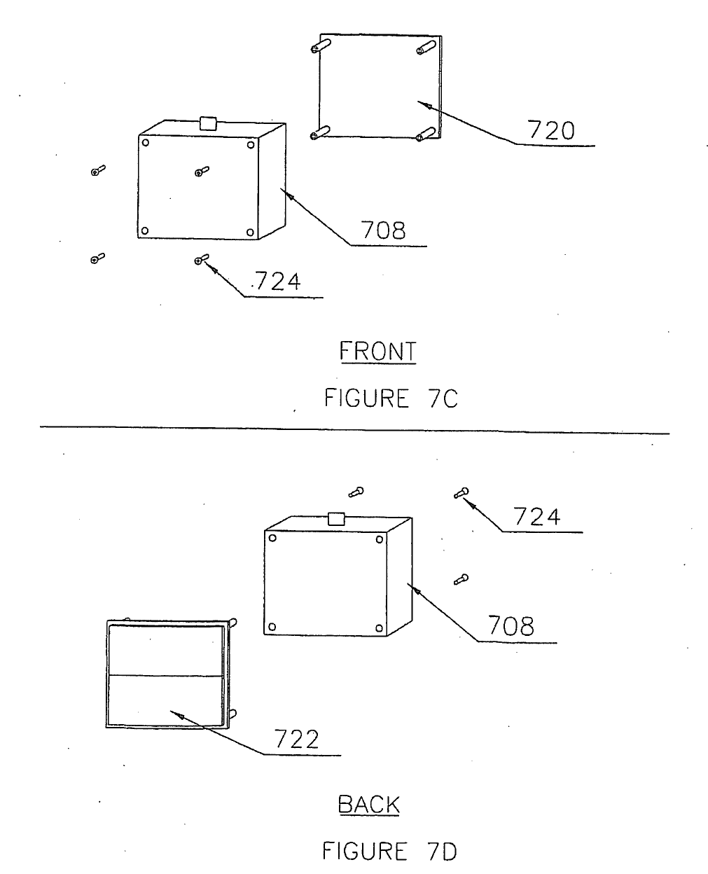

Turing to FIG. 7A, a seismic switch 708 is shown as part of a control panel 700. The control panel 700 can be either a fire control panel or a door control panel. The control panel 700 includes an external housing in which the various components are mounted. These include circuit board 702 which includes a controller for the panel's functionality, standard batteries 704 and a power supply 706. As shown, seismic switch 708 us approximately the same size as the standard batteries 704 and fits in the space which is ordinarily provided in the control panel for them. The seismic switch is mounted to the back of the control panel by the mounting plate (shown in FIGS. 7C and 7D). Wires run from the seismic switch 708 to the circuit board 702 through a connector 709 (preferably a Cannon plug) to provide power to the seismic switch and to provide the seismic signal (or switch) to the controller on the circuit board 702.

In an alternative configuration, the seismic switch 708 is mounted outside the control panel 700 and the connecting wires run through a hole in the side of the control panel's enclosure. In this configuration of the seismic switch 708, the connecting cable is armored to prevent cutting or shorting of the cables wires. In addition, this configuration requires a keyed reset switch (which is not necessary if the seismic switch 708 is contained within a keyed control panel).

Similar to a smoke sensor, the seismic sensor should be periodically tested. The frequency-of such testing will depend upon fire code and standards. Absent a code or standard establishing otherwise, the testing should be conducted on the order to every six (6) months.

To test the seismic sensor, it is dismounted from inside the control panel 700, disconnected by connector 709 and placed on a vibration table. This is shown in FIG. 7B. A programmed controller 712 operates the vibration table 710. With reference to the actuation points shown in FIG. 5, the seismic sensor 708 is checked at a number of different points to ensure proper operation. First the vibration table 710 is set at low amplitude and a long period (e.g., 0.05 g with 1.0 second period). This should cause the detection of an earthquake. The seismic sensor is then reset and a new vibration applied which should not activate any alarm condition (e.g., 0.20 g with a 0.1 second period). Preferably, test points at 1, 2.5, 5 and 10 Hz are made. Additional points may be used to further ensure proper operation.

The proper operation of the seismic switch 708 can be determined from either the front panel lights provided on the seismic switch or from the signals provided to the circuit board 702 or from the programmed controller. If the lights on the front panel are used, then a separate light is provided on the front panel for each type of alarm condition. If the seismic switch 708 passes these tests, it is operating properly and is re-mounted in the control panel 700 as shown in FIG. 7A.

In another preferred test configuration, the seismic switch 708 is removed from the control panel 700 and an extension cord is used to extend the length of the connection between the control circuit 702 and the seismic switch 708. This permits the testing of the operation of the control panel circuitry along with the seismic switch 708. This configuration may be used to comply with any applicable codes or standards.

Turning to FIGS. 7C and 7D, one preferred method of mounting the seismic switch 708 is further described. A mounting plate 720 is provided. On the back face of the mounting plate 720, structural tape 722 bonds it to the control panel enclosure (shown in FIG. 7B). A stand-up is provided on each corner of the mounting plate 720. Screws 724 pass through the corners of the seismic switch 708 to engage the stand-ups.

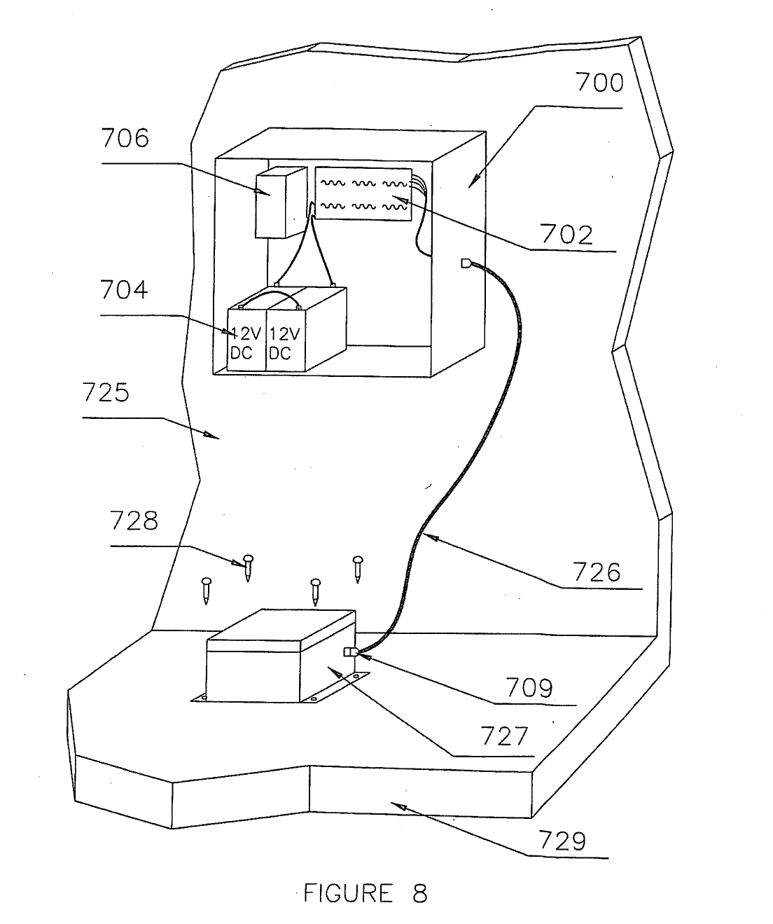

Turning to FIG. 8, another preferred embodiment is shown. In some applications, the walls may themselves move or vibrate, which can cause false alarms. Where the floor 802 is more stable, the seismic detector 800 is preferably mounted there. Mounting screws 804 hold the seismic sensor 800 in place. Signals from the seismic sensor 800 pass through a connector 806 mounted in the housing. These pass through a cable 808 and then through another connector 810 mounted in the housing. These pass through a cable 808 and then through another connector 810, as they enter the security panel 812. These signals are then fed to the control circuitry 814. Unlike the seismic sensor 800, the security panel 812 can be mounted on wall. 816 as it is not sensitive to movement or vibration. The security panel includes standard components such as a power supply 818 and batteries 820.

The sensors used in the seismic sensor system of the present invention includes three Low G micro machined accelerometers manufactured by Freescale Semiconductor and have model no> MMA1260D. These accelerometers are in the MMA series of silicon capacitive, micro machined accelerometers that feature signal conditioning, a 2-pole low pass filter and temperature compensation. Zero-g offset full scale span and filter cut-off are factory set and require no external devices. This accelerometer is a surface micro machined capacitive sensing cell (g-cell) and a CMOS signal conditioning ASIC contained on a single integrated circuit package. The sensing element is sealed hermetically at the wafer level using a bulk micro machined “cap” wafer.

The g-cell is a mechanical structure formed from semiconductor materials (polysilicon) using semiconductor processes (masking and etching). It can be modeled as two stationary plates with a moveable plate in-between. The center plate can be deflected from its rest position by subjecting the system to an acceleration.

When the center plate deflects, the distance from it to one fixed plate will increase by the same amount that the distance to the other plate decreases. The change in distance is a measure of acceleration.

The g-cell plates form two back-to-back capacitors. As the center plate moves with acceleration, the distance between the plates changes and each capacitor's value will change, (C=Ae/D). Where A is the area of the plate, e is the dielectric constant, and D is the distance between plates.

The CMOS ASIC uses switched capacitor techniques to measure the g-cell capacitors and extract the acceleration data from the difference between the two capacitors. The ASIC also signal conditions and filters (switched capacitor) the signal, providing a high level output voltage that is ratio metric and proportional to acceleration.

The Freescale Semiconductor accelerometers contain an onboard 2-pole switched capacitor filter. A Bessel implementation is used because it provides a maximally flat delay response (linear phase) thus preserving pulse shape integrity. Because the filter is realized using switched capacitor techniques, there is no requirement for external passive components (resistors and capacitors) to set the cut-off frequency.

The Freescale Semiconductor accelerometer sensor provides a self-test feature that allows the verification of the mechanical and electrical integrity of the accelerometer at any time before or after installation. A fourth “plate” is used in the g-cell as a self-test plate. When the user applies a logic high input to the self-test pin, a calibrated potential is applied across the self-test plate and moveable plate. The resulting electrostatic force (Fe=½Av²/d²) causes the center plate to deflect. The resultant deflection is measured by the accelerometer's control ASIC and a proportional output voltage results. This procedure assures that both the mechanical (g-cell) and electronic sections of the accelerometer are functioning.

As those skilled in the art will appreciate, many variations and modifications can be made to the preferred embodiments described above without departing from the spirit of the invention. All such variations and modifications are intended to be encompassed within the scope of the following claims.

I claim the following:

1. A seismic detection sensor comprising:
at least two seismic sensors for generating electrical signals in response to seismic movement;
detection circuitry operably coupled with said seismic sensors to receive said signals, said circuitry being configured to detect an occurrence of a seismic event based on said signals;
the at least two seismic sensors each being a low G micro machined accelerometer.

2. The seismic detection sensor of claim 1, and further comprising:
the low G micro machined accelerometer is a silicon capacitive accelerometer.

3. The seismic detection sensor of claim 1, and further comprising:
the low G micro machined accelerometer is a surface micro machined capacitive accelerometer with a CMOS signal conditioning ASIC contained in a single integrated circuit package.

4. The seismic detection sensor of claim 3, and further comprising:
the sensing element is sealed hermetically at the wafer level.

5. The seismic detection sensor of claim 3, and further comprising:
the accelerometer is a mechanical structure formed from semiconductor materials using semiconductor forming processes.

6. The seismic detection sensor of claim 3, and further comprising:
the accelerometers each include two stationary plates with a moveable plate in-between.

7. The seismic detection sensor of claim 3, and further comprising:
the accelerometers each contain an onboard 2-pole switched capacitor filter.

8. The seismic detection sensor of claim 7, and further comprising:
the filter uses a Bessel implementation to provide a linear response to preserve pulse shape integrity.

9. The seismic detection sensor of claim 7, and further comprising:
the accelerometers require no external resistors or capacitors to set a cut-off frequency.

10. The seismic detection sensor of claim 3, and further comprising:
the sensor includes three accelerometers set at substantially 90 degrees from each other to form an X-axis accelerometer, a Y-axis accelerometer and a Z-axis accelerometer.

11. The seismic detection sensor of claim 3, and further comprising:
the seismic detection sensor is sensitive to an earthquake signal of less than 0.05 g.

12. The seismic detection sensor of claim 3, and further comprising:
the accelerometers are a Freescale Semiconductor accelerometer of model number MMA1260D.

13. The seismic detection sensor of claim 3, and further comprising:
the seismic detection sensor includes means to differentiate between an earthquake and an explosion.
